(19) United States
(12) Patent Application Publication
(10) Pub. No.: US 2015/0160646 A1
(43) Pub. Date: Jun. 11, 2015

(54) SYSTEMS AND METHODS FOR PREVENTING TOOL DAMAGE IN A COMPUTER CONTROLLED RESURFACING MACHINE

(71) Applicants: Ben Ward, Kent, WA (US); Andrew C. Rottler, Kent, WA (US)

(72) Inventors: Ben Ward, Kent, WA (US); Andrew C. Rottler, Kent, WA (US)

(21) Appl. No.: 14/562,447

(22) Filed: Dec. 5, 2014

Related U.S. Application Data
(60) Provisional application No. 61/913,123, filed on Dec. 6, 2013.

(51) Int. Cl. G05B 19/4061

(52) U.S. Cl. CPC G05B 19/4061; G05B 2219/49072

(57) ABSTRACT

A systems and methods for preventing tool damage in a computer controlled machining apparatus is provided. Conventional CNC machining apparatuses do not provide techniques for checking whether tool movement will interfere with one or more surfaces of the workpiece to be machined. The systems and methods carried out by the systems described herein address at least these deficiencies by providing a “crash test” or tool damage prevention routine that tests whether or not damage may occur based on a contact with the workpiece.

### CROSS-REFERENCE TO RELATED APPLICATION

This application claims the benefit of U.S. Provisional Application No. 61/913123, filed Dec. 6, 2013, the disclosure of which is incorporated by reference herein.

### BACKGROUND

Engine rebuilding has become a popular alternative to purchasing new engines in such fields as automobiles and watercraft. In some high performance industries such as professional racing, teams build and rebuild their engines before every racing event. To the average consumer and the racing professional alike, accurate machining and rebuilding is a necessity for good performance and reliability of an engine. Resurfacing cylinder heads and engine blocks is an essential aspect of engine building/rebuilding today, whether the work is being done by a production engine rebuilder, a high performance specialist or small custom shop.

Common types of machines used for rebuilding an engine include computer numerical controlled (CNC) machines. These machines can be configured to carry out one or more machining or resurfacing operations, including polishing, boring, honing, reaming, drilling, etc., and are commercially available from Rottler Manufacturing and Sunnen, among others.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In accordance with one an aspect of the present disclosure, a computer implemented method is provided for resurfacing at least one surface of a workpiece with a tool. The method includes moving the tool to a first position, moving the tool from the first position to one or more test positions, the one or more test positions associated with the at least one surface of the workpiece, and determining if tool damage will occur based on the movement of the tool from the first position to the one or more test position. If it is determined that tool damage will occur, the method stops movement of the tool. If it is determined that tool damage with not occur, the method proceeds to resurface the at least one surface of the workpiece.

In accordance with another aspect of the present disclosure, a computer controlled apparatus is provided for resurfacing at least one surface of a workpiece. The apparatus includes a workpiece support configured to support a workpiece having the at least one surface, a tool carried by a spindle, one or more linear drives configured and arranged to move the tool, with respect to the workpiece, to a first position and from the first position to one or more test positions, the one or more linear drives including, in one embodiment, one or more electric motors, and one or more load sensors configured to sense the load of the one or more motors as the linear drives move the tool from the first position to the one or more test positions. The apparatus further includes one or more computing devices configured to control the movement of the tool by the one or more linear drives and determine if tool damage will occur based on the movement of the tool from the first position to the one or more test position.

In accordance with another aspect of the present disclosure, a computer controlled apparatus is provided for resurfacing at least one surface of a workpiece. The apparatus includes a workpiece support configured to support a workpiece having the at least one surface, a tool carried by a tool carriage, one or more linear drives configured and arranged to move the tool, with respect to the workpiece, to a first position and from the first position to one or more test positions, the one or more linear drives including, in one embodiment, one or more electric motors. The apparatus further includes one or more computing devices that include a machining module configured to control the movement of the tool for resurfacing the at least one surface of the workpiece, and a tool damage prevention module configured to determine whether the tool contacts a surface of a workpiece in a potentially damaging manner prior to resurfacing.

### DESCRIPTION OF THE DRAWINGS

The foregoing aspects and many of the attendant advantages of the disclosed subject matter will become more readily appreciated as the same become better understood by reference to the following detailed description, when taken in conjunction with the accompanying drawings, wherein:

FIG. 1 illustrates one example of a computer controlled resurfacing machine, the resurfacing machine configured to carry out one or more examples of tool damage prevention methods in accordance with aspects of the present disclosure;

FIG. 2 is a partial view of the resurfacing machine of FIG. 1;

FIG. 3 is a block diagrammatic view of one example of a control system in accordance with aspects of the present disclosure;

FIG. 4 is one example of a machining method in block diagrammatic form in accordance with aspects of the present disclosure;

FIG. 5 is a routine carried out by the method of FIG. 4 that implements a tool damage preventing routine;

FIG. 6 is a screen shot rendered by one example of a HMI in accordance with aspects of the present disclosure;

FIG. 7 is another screen shot rendered by one example of a HMI in accordance with aspects of the present disclosure; and

FIG. 8 is another screen shot rendered by one example of a HMI in accordance with aspects of the present disclosure.

### DETAILED DESCRIPTION

The detailed description set forth below in connection with the appended drawings where like numerals reference like elements is intended as a description of various embodiments of the disclosed subject matter and is not intended to represent the only embodiments. Each embodiment described in this disclosure is provided merely as an example or illustration and should not be construed as preferred or advantageous over other embodiments. The illustrative examples provided herein are not intended to be exhaustive or to limit the claimed subject matter to the precise forms disclosed. Similarly, any steps described herein may be interchangeable with other steps, or combinations of steps, in order to achieve the same or substantially similar result.

The follow description sets forth examples of systems and methods for preventing tool damage in a computer controlled machining apparatus, such as a honing machine. Conventional CNC machining apparatuses do not provide techniques for checking whether tool movement will interfere with one or more surfaces of the workpiece to be machined prior to machining. The examples provided herein address at least these deficiencies by providing “crash test” or tool damage prevention techniques that test whether or not damage may occur based on, for example, contact with the workpiece.

In the following description, numerous specific details are set forth in order to provide a thorough understanding of exemplary embodiments of the present disclosure. It will be apparent to one skilled in the art, however, that many embodiments of the present disclosure may be practiced without some or all of the specific details. In some instances, well-known process steps have not been described in detail in order not to unnecessarily obscure various aspects of the present disclosure. Further, it will be appreciated that embodiments of the present disclosure may employ any combination of features described herein.

Although some embodiments of the present disclosure will be described hereinafter with reference to honing a cylinder, it will be appreciated that aspects of the present disclosure have wide application, and therefore, may be suitable for use with many other types of machining or resurfacing operations, including polishing, boring, reaming, drilling, etc. Accordingly, the following descriptions and illustrations herein should be considered illustrative in nature, and thus, not limiting the scope of the claimed subject matter.

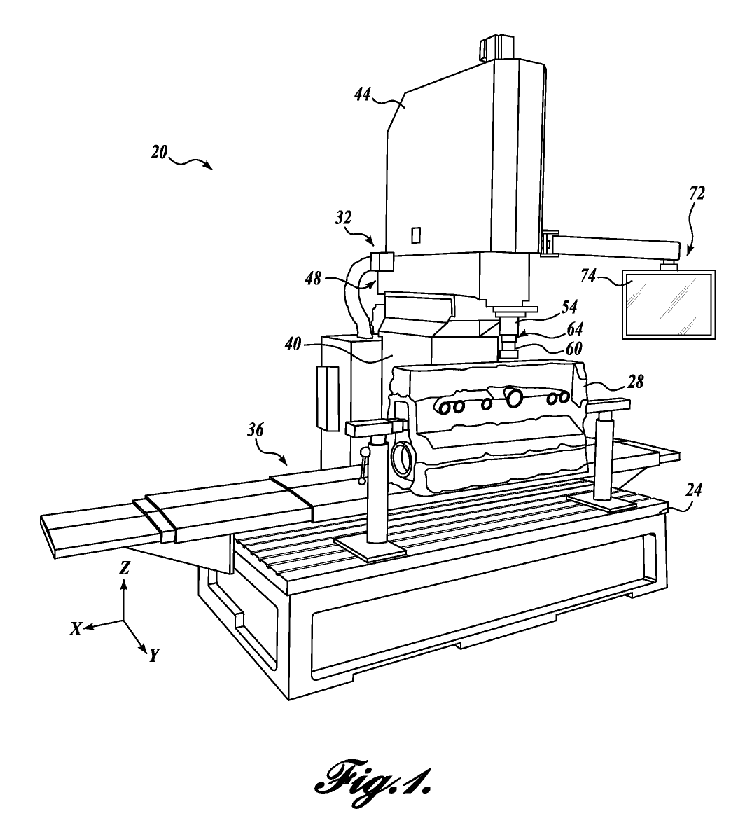

Turning now to FIG. 1, there is shown one example of a computer controlled (e.g., CNC, etc.) machining apparatus, generally designated 20, configured to carry out one or more methods of the present disclosure. The machining apparatus 20, which can either be single purpose or multi-purpose, generally includes a work table 24 onto which a work piece, such as an internal combustion engine block 28, is mounted. The work table 24 in some embodiments may be slotted to accommodate conventional fixation devices for stationarily mounting a workpiece, such as engine block 28, to the work table 24 in a suitably fixed position.

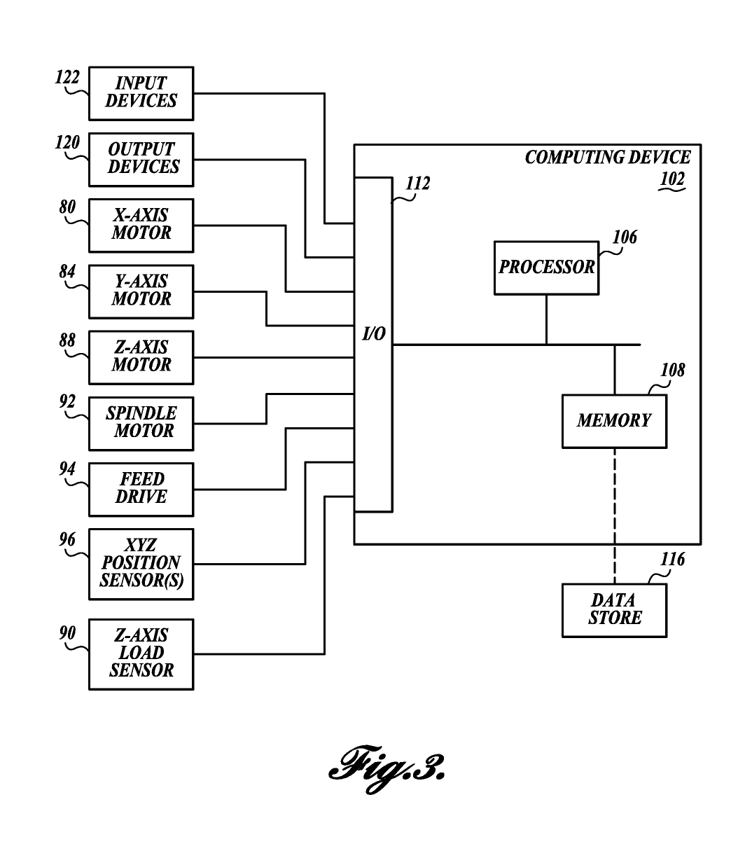

The machining apparatus 20 also includes a tool support 32, which is mounted for reciprocating movement via a linear stage 36 oriented in the X-direction. The linear stage 36 comprises a linear slide type bearing interface to restrict motion of the tool support 32 in only the X-direction, and a linear drive system for providing reciprocating motion to the tool support 32. The linear drive system includes a conventional ball screw mechanism (hidden in FIG. 1) or the like actuated by, for example, a drive motor 80 (see FIG. 3) under controlled by a control system 100. In some embodiments, the drive motor 80 can include but is not limited to AC or DC electric motors, stepper motors, servo motors, etc.

The tool support 32 is directly or indirectly mounted to the ball nut of the ball screw mechanism. As such, the tool support 32 moves in a reciprocating manner as the ball screw is rotated via the drive motor 80 under control of the control system 100. As the ball screw rotates, the number of rotations by and the rotational position of the ball screw are precisely detectable by an encoder or other sensor 98 (FIG. 3) communicatively connected to the drive motor 80 and/or control system 100. Sensors may also be used to sense the position of the ball nut, as known in the art.

In some embodiments, the tool support 32 includes a base section 40 and an upper section 44. As shown in the embodiment of FIG. 1, the upper section 44 is controllably movable with respect to the base section 40. In that regard, in one embodiment, the upper section 44 is mounted to the base section 40 for reciprocating movement via a linear stage 48 oriented in the Y-direction. The linear stage comprises a linear slide type bearing interface to restrict motion of the upper section 44 in only the Y-direction, and a linear drive system for providing the reciprocating motion to the upper section 44. The linear drive system includes a conventional ball screw mechanism (hidden in FIG. 1) or the like actuated by, for example, a drive motor 84 (see FIG. 3) under control by a control system 100. In some embodiments, the drive motor 84 can include but is not limited to AC or DC electric motors, stepper motors, servo motors, etc.

The upper section 44 is directly or indirectly mounted to the ball nut of the ball screw. As such, the upper section 44 moves in a reciprocating manner as the ball screw is rotated via the servomotor associated therewith. As the ball screw rotates, the number of rotations by and the rotational position of the ball screw are precisely detectable by an encoder or other sensor 98 (FIG. 3) communicatively connected to the drive motor 84 and/or control system 100. Sensors may also be used to sense the position of the ball nut, as known in the art.

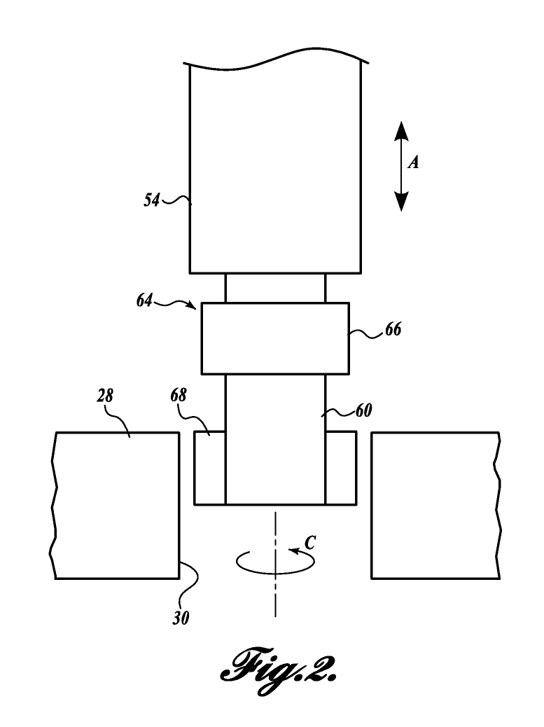

Referring to FIGS. 1 and 2, a spindle carriage 54 is supported by the upper section 44, and is movable in a reciprocating stroking action, denoted by arrow A (FIG. 2). The reciprocating motion can be implemented by a linear motion system, such as ball screw mechanism driven by a drive motor 88 under control by a control system 100. The spindle carriage 54 is directly or indirectly mounted to the ball nut of the ball screw mechanism. As such, the spindle carriage 54 moves in a reciprocating or stroking manner as the ball screw is rotated via the drive motor 88. As the ball screw rotates, the number of rotations by and the rotational position of the ball screw are precisely detectable by an encoder or other sensor 98 (FIG. 3) communicatively connected to the drive motor 88 and/or control system 100. Sensors may also be used to sense the position of the ball nut, as known in the art. As will be described in more detail below, a load sensor 90 is provided for monitoring the load placed on the drive motor 88 when the drive motor 88 strokes the spindle carriage 54.

As shown in FIGS. 1 and 2, the spindle carriage 54 is shown supported for reciprocal stroking action in a vertical direction (i.e., Z-axis), but it should be understood that stroking in other directions (i.e., X-axis or Y-axis) is also contemplated with embodiments of the present disclosure. In these and other embodiments, the base section 40 and the upper section 44 of the tool support 32 can be configured to be independently movable in a control manner in other coordinate axes, respectively. As will be described in more detail below, movement of the spindle carriage inserts and withdraws an associated machining tool, such as a honing tool 60, carried by a spindle 64 into and out of a cylinder bore 30 of a workpiece 28. As will be further described in more detail below, the honing tool 60 is rotated via spindle 64 about an axis denoted by arrow C, for effecting the desired honing of surface 30 of workpiece 28.

Still referring to FIG. 2, the spindle 64 is carried by the spindle carriage 22 and is rotatably driven by a spindle drive motor 92 (see FIG. 3) in a conventional manner. The spindle 64 includes a tool attachment interface 66 for selectively attaching the machine tool 60 for co-rotation. As shown in the embodiment of FIG. 2, the tool 60 is in the form of a honing tool and is selectively coupled to the spindle 64. However, the tool 60 can be any conventional or further developed machining tool, and can be selected based on the type of machine operation (e.g., boring, reaming, honing, drilling, milling, etc.) to be carried out by the machining apparatus. Generally described, the honing tool 60 includes an elongate mandrel carrying one or more honing elements 68 such as abrasive stones or sticks, which can be moved radially outwardly and inwardly relative to the mandrel via actuation of a conventional feed drive 94 (see FIG. 3) under control of the control system 100 as known in the art.

In operation, once inserted into a suitable portion of a work piece 28, such as a cylinder bore 30, the honing tool 60 can be rotated, as denoted by arrow C, via the spindle 64 under control of the control system 100 for abrading and honing a surface of a work piece. In a typical application, as spindle carriage 54 is reciprocally stroked upwardly and downwardly, as denoted by arrow A, honing tool 60 will rotate in one direction or the other, as denoted by arrow C, within a hole or bore in a workpiece, for providing a desired size, surface finish and/or shape to one or more surfaces defining the bore or hole.

In other embodiments, the upper section 44 is fixedly connected to the base section 40, and as a result, adjustment in the Y- direction is not available. As such, the tool 60 in these embodiments is capable of moving with respect to the workpiece 28 in an automated manner in the X and Z axis directions. In other embodiments, the workpiece 28 and/or the tool support 32 can be mounted on an X-Y table or the like in order to control movement of the tool 60 in both the X and Y axis directions.

Other linear drive systems can be practiced with embodiments of the present disclosure, including drive motor actuated cam linkage mechanisms, roller screws, rack and pinion, hydraulic or pneumatic cylinders, chain or belt drives, etc. For example, any of the ball screw mechanisms described herein could be substituted with other means of rotary to linear motion conversion (e.g. rack & pinion, etc.,) or that the motor, encoder/sensor and ball screw together could be substituted with a linear motor and linear encoder, or any other system of providing precise position controlled linear motion.

In some embodiments, examples of machining apparatus that may be practiced with embodiments of the present disclosure include but are not limited to the P70 and P79 CNC machining stations available from Rottler Manufacturing, Kent, Wash.

As briefly described above, the drive motors 80, 84, and 88, spindle motor 92, a feed drive 94, are operated under the control of a control system 100. FIG. 3 illustrates one example of the control system 100 in block diagrammatic form. As will be described in more detail below, the control system 100 includes one or more computing devices 102 suitably programmed to interface with a system operator via a control station 72 (see FIG. 1), and to carry out either automated or manually inputted instructions. As will be described in more detail below, the control station 72 includes one or more human machine interface devices, including display 74. At the control station 72, the system operator interfaces with the control system 100 via human machine interface devices such as one or more displays, keyboards, joysticks, trackballs, touchpads, control dials, and/or the like. In some embodiments, the one or more computing devices render a graphical user interface (GUI) on the display 74 in order to graphically interface with the system operator. From the input of various data related to the workpiece and to the type of machine operation to be performed, the one or more computing devices 102 implements, for example, CNC and/or CAM machining instructions in order to machine the mounted workpiece 28 with the tool 60.

One example of the one or more computing devices 102 will now be described in more detail. In some embodiments, the one or more computing devices 102 either seperately or in combination may include at least one processor 106 or central processing unit (CPU), a memory 108, and I/O circuitry 112 suitably interconnected via one or more buses. Depending on the exact configuration and type of device, the memory 108 may include system memory in the form of volatile or nonvolatile memory, such as read only memory (“ROM”), random access memory (“RAM”), EEPROM, flash memory, or similar memory technology. The system memory is capable of storing one or more programs, that are immediately accessible to and/or currently being operated on by the CPU. In this regard, the CPU serves as a computational center of the computer 100 by supporting the execution of instructions.

The memory 108 may also include storage memory, and may include a data store 116. The storage memory may be any volatile or nonvolatile, removable or nonremovable memory, implemented using any technology capable of storing information. Examples of storage memory include but are not limited to a hard drive, solid state drive, CD ROM, DVD, or other disk storage, magnetic cassettes, magnetic tape, magnetic disk storage, and the like. The information stored in the storage memory to be accessed by the CPU includes but is not limited to program modules, such as an operating system (Microsoft Corporation's WINDOWS®, LINUX, Apple's Leopard, etc.), and one or more CNC modules for carrying out one or more machining operations of the apparatus. Generally, program modules may include routines, applications, objects, components, data structures, etc., that perform particular tasks or implement particular abstract data types. In some embodiments, the one or more CNC machining modules are configured to operate the apparatus based, in part, on obtained data (e.g., inputted from user, access from operational history, etc.) in order to carry out one or more machining operations (e.g., boring, honing, reaming, milling, porting, etc.) The memory 108 also stores one or more tool damage prevention modules, etc., that test whether or not damage may occur based on tool contact with the workpiece.

As used herein, the term processor or processing unit is not limited to integrated circuits referred to in the art as a computer, but broadly refers to a microcontroller, a microcomputer, a microprocessor, a programmable logic controller, an application specific integrated circuit, other programmable circuits, combinations of the above, among others. In one embodiment, the processor 106 executes instructions stored in memory 108, such as CNC machining instructions, CAM instructions, etc.

The modules stored in memory 108 as well as other modules associated with the control system 100 may include one or more sets of control algorithms, determination algorithms, numerical control instructions, etc., including resident program instructions and calibrations stored in one of the storage mediums and executed to provide the desired functions. Information transfer to and from the modules can be accomplished by way of a direct connection, a local area network bus and a serial peripheral interface bus.

The algorithms may be executed during preset loop cycles such that each algorithm is executed at least once each loop cycle. Algorithms stored in the non-volatile memory devices are executed by the processor to monitor inputs from the sensing devices, such as sensors 90, 96, etc., and other data transmitting devices or polls such devices for data to be used therein. Loop cycles are executed at regular intervals, for example each 3.125, 6.25, 12.5, 25 and 100 milliseconds during ongoing operation of the apparatus. Alternatively, algorithms may be executed in response to the occurrence of an event.

Still referring to FIG. 3, the processor 106 communicates with various data sources 90, 94, 120, 122 (sensors, HMI devices), with drive motors 80, 84, 88, etc., directly or indirectly via an input/output (I/O) interface 112 and suitable communication links. The interface 112 may be implemented as a single integrated interface that provides various raw data or signal conditioning, processing, and/or conversion, short-circuit protection, and/or the like. Alternatively, one or more dedicated hardware or firmware chips may be used to condition and process particular signals before being supplied to/from the processor 106. In some embodiments, the signals transmitted from the interface 112 may be suitable digital or analog signals to control components of the system 100. Other components may be employed, such as control circuits, PLCs, etc., as known in the art, for controlling the drive motors (e.g., AC or DC electric motors, stepper motors, servo motors). For example, one or more devices may be utilized to convert control signals from the I/O into appropriate device specific control signals to be carried out by the motors, etc. In some embodiments, the I/O may include these and/or other control devices.

The one or more computing devices 102 may also interface with one or more output devices 120 in the form of graphical display 74 (e.g., liquid crystal display (LCD), light emitting polymer display (LPD), plasma display, Light emitting Diode (LED) display, Organic Light emitting Diode (OLED) display, etc.). The one or more computing devices 102 may also include one or more input devices 122, such as a keyboard, touch pad, joystick, cameras, or a pointing device, among others. In one embodiment, the display 74 can also be configured as a touchscreen for inputting data. The output devices 120 and input devices 122 can also be referred to as HMI devices herein. The output devices and the input devices are suitably connected through appropriate interfaces of the I/O circuitry. As would be generally understood, other input/output devices may also be connected to the processor in a similar manner.

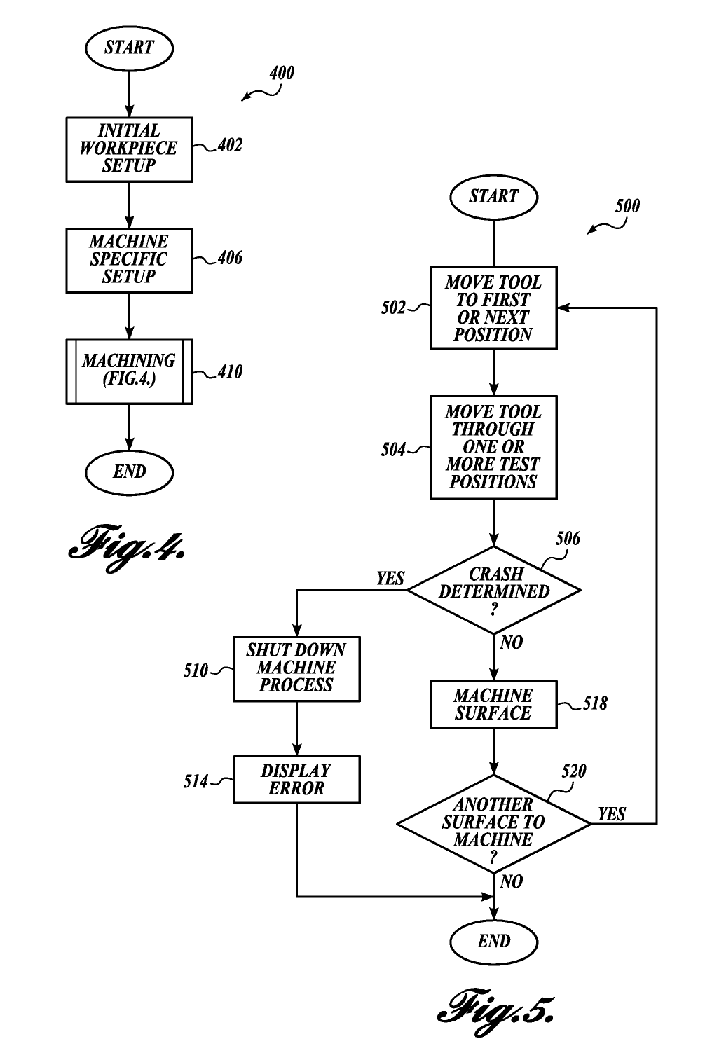

Turning now to FIG. 4, there is shown a flowchart depicting one example of a method, designated 400, for machining a workpiece, such as engine block 28, with the apparatus 20. The method 400 will be explained with reference to a honing operation, although it will be appreciated that method 400 can be employed to carry out other machining operations, such as porting, boring, reaming, drilling, tapping, surfacing, resleeving, etc.

The method begins at block 402, where an initial setup associated with a particular machining operation, such as honing, porting, or boring, of a workpiece, such as an engine block, cylinder head, etc., is carried out. The initial setup includes one or more operations conducted by the user and/or the apparatus. Initially, a selected workpiece, such as an internal combustion engine block 28, is mounted to the work bench 24 via an appropriate fixture and is registered relative to the orthogonal coordinates of the machine 20. Registering provides the control system 100 with the reference coordinates of the fixated workpiece with respect to the “home” position of the tool 60.

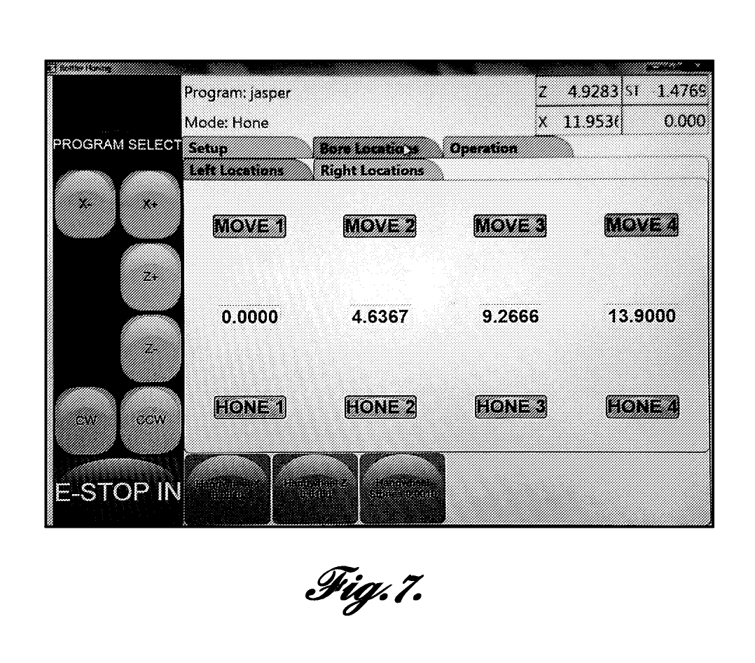

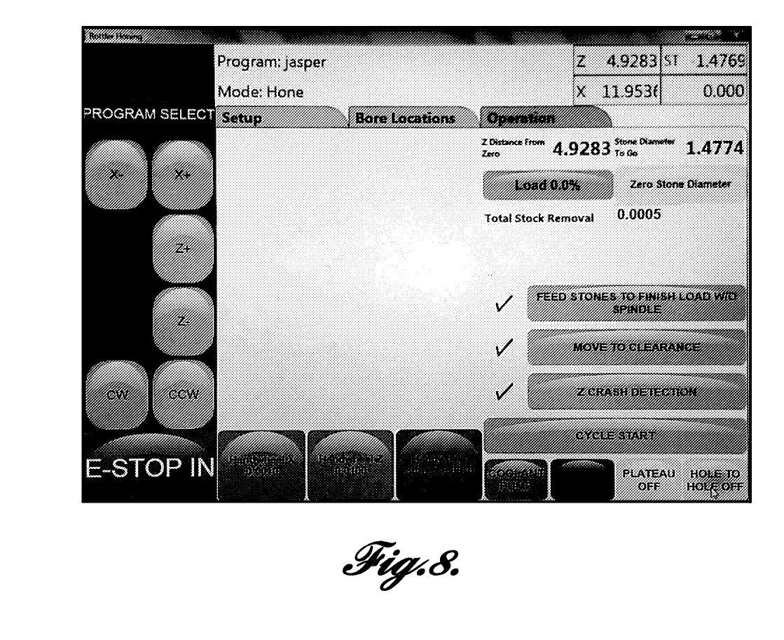

Next, at block 406, a machine specific or resurfacing specific set up is carried out. For example, entry of various data from either the HMI or from one or more data files stored and/or transferred to memory 108 associated with the specific machining operation is carried out. The data may include but is not limited to reference data, workpiece parameter (e.g., size of cylinder bore, depth of cylinder bore, bore to bore distance, etc.) data, tool damage prevention data, such as upper stroke data, lower stroke date, etc. It will be appreciated that the data is dependent on the type of machining operation to be carried out. If the apparatus 20 is configured for multi-use, the initial setup will include the selection of machining operation. This may be accomplished via prompt, pull down menu, touchscreen icon, etc. FIGS. 6 and 7 depict screen shots displaying examples of parameters to be entered for a selected machining process, such as honing.

After the machine specific setup is completed at block 406, the method 400 continues to block 410 where the machining of the workpiece is carried out. Machining of the workpiece may include an operational sequence or cycle of machine movements that result in a resurfacing of a workpiece surface or surfaces. As will be appreciated, the operational sequence can be automated or semi-automated by the control system via CNC instructions, CAM instructions and/or the like, can be manually carried out via the HMI, or combinations thereof. In one example, the operational sequence may include, for example, moving of the spindle 64, and thus, the tool 60 from the home position to a first position in which the tool 60 is centered over the first cylinder bore 30 to be treated, stroking the tool through the first bore and rotating the tool in order for the tool 60 to resurface the bore. If the workpiece includes multiple bores, the operational sequence includes tool movement to the next position (e.g., next bore, etc.) and the process is repeated. As will be described in more detail below, as the apparatus carries out the machining process at block 410, a tool damage prevention test, such as a crash test, is implemented in order to prevent unnecessary damage to the tool 60 caused by operator error, workpiece casting errors, workpiece variations, etc. After block 410, the method ends. FIG. 8 depicts a screen shot displaying an example of an HMI displayed by display 74 during the selected machining process, such as honing.

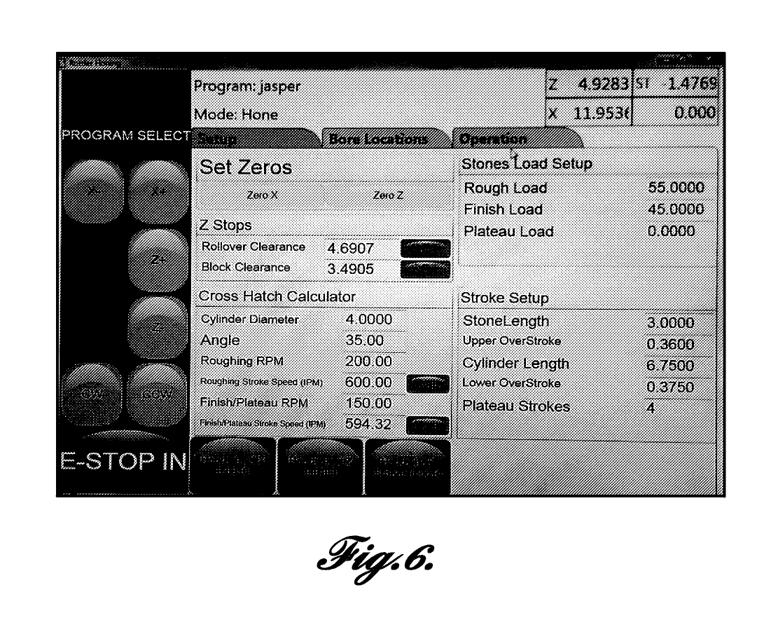

As was described in some detail above, and in accordance with aspects of the present disclosure, a “crash test” or tool damage prevention routine is carried out during the operational sequence of the machining at block 410. In that regard, block 410 can be implemented in two stages: a crash test stage; and a machining stage. FIG. 5 is a flowchart depicting one example of a method for testing whether or not damage may occur based on tool contact with the workpiece. Once the tool 60 has been moved to the first or next position at block 502 and prior to any machining action as briefly described above, the method proceeds to block 504, where a series of tool movements are carried out about and/or along, for example, the Z-axis for testing against possible crashes. As used herein, the term “crash” is used to mean any contact of the tool 60 against the workpiece or the machine that could result in damage to the tool. For example, in a honing sequence, the honing tool is lowered from the starting reference or first position into the first bore that is subject to future honing to check for possible interference. In other words, contact is monitored as the tool 60 is lowered toward and into the cylinder bore 30. Next, the honing tool is reciprocated vertically through the bore to check for possible interference. The honing tool then travels below the bore an amount referred to as the “over stroke” distance (see FIG. 6) to again check for possible interference. During each sequential movement, a test is carried out to determine whether a crash occurred at 506.

In some embodiments, a crash can be determined as the tool 60 is moved through the series of movements outlined above when the load on one of the drive motors increases beyond normal operating values as a result of contact of the tool 60 with a surface of the workpiece 28. The load can be monitored by a variety of techniques. In some embodiments, one or more operating parameters of the drive motor 80, 84, and/or 88 are sensed. For example, the voltage and/or amperage of the drive motor 88 can be sensed via load sensor 90. The one or more computing devices 102 are configured to obtain the sensed load and compare one or more values associated with the sensed load to a threshold value. If the threshold value is exceeded, then a crash is determined to have occurred. The load sensed by the sensor 90 or calculated by sensor data processed by components of the system 100 can include absolute load, relative load, rate of change of the load, etc. If the first movement occurs without a determined crash, the movement sequence continues by moving the tool 60 to the next position, and so on. If a crash is detected at block 506 during any movement segment, the operation of machine 20 stops at block 510 and an output is optionally displayed on display 74 indicating a crash occurred at block 514.

Once each test for the 1^{st} cylinder bore is conducted, and passed, the method 500 continues to block 518, where the resurfacing operation, e.g., honing, boring, etc., is carried out under the control of the control system 100. The method 500 then determines whether another surface, such as a 2^{nd} cylinder bore, of the workpiece is programmed to be resurfaced at 520. If so, the method 500 returns to block 502. If not, the method ends.

The principles, representative embodiments, and modes of operation of the present disclosure have been described in the foregoing description. However, aspects of the present disclosure which are intended to be protected are not to be construed as limited to the particular embodiments disclosed. Further, the embodiments described herein are to be regarded as illustrative rather than restrictive. It will be appreciated that variations and changes may be made by others, and equivalents employed, without departing from the spirit of the present disclosure. Accordingly, it is expressly intended that all such variations, changes, and equivalents fall within the spirit and scope of the present disclosure.

The embodiments of the invention in which an exclusive property or privilege is claimed are defined as follows:

1. A computer implemented method for resurfacing at least one surface of a workpiece with a tool, comprising:
moving the tool to a first position;
moving the tool from the first position to one or more test positions, the one or more test positions associated with the at least one surface of the workpiece;
determining if tool damage will occur based on the movement of the tool from the first position to the one or more test position;
if it is determined that tool damage will occur, stop movement of the tool;
if it is determined that tool damage with not occur, resurface the at least one surface of the workpiece.

2. The computer implemented method of claim 1, further comprising
displaying an error message if it is determined that tool damage will occur.

3. The computer implemented method of claim 1, wherein said determining if tool damage will occur includes
determining if the tool contacted the workpiece when the tool is moved from the first position to the one or more test positions.

4. The computer implemented method of claim 3, wherein said determining if the tool contacted the workpiece when the tool is moved from the first position to the one or more test positions includes
monitoring one or more load sensors configured to sense load of one or more respective motors associated with the tool, the one or more motors configured to move the tool from the first position to the one or more test positions.

5. The computer implemented method of claim 4, wherein said determining if the tool contacted the workpiece when the tool is moved from the first position to the one or more test positions includes
comparing the sensed load to a threshold value; and
determining a contact occurred if the sensed load exceeds the threshold value.

6. The computer implemented method of claim 5, wherein the sensed load is one of an absolute load, a relative load, and rate of change of the load.

7. A computer controlled apparatus for resurfacing at least one surface of a workpiece, the apparatus comprising:
a workpiece support configured to support a workpiece having the at least one surface;
a tool carried by a spindle;
one or more linear drives configured and arranged to move the tool, with respect to the workpiece, to a first position and from the first position to one or more test positions, the one or more linear drives including one or more electric motors;
one or more load sensors configured to sense the load of the one or more motors as the linear drives move the tool from the first position to the one or more test positions;
one or more computing devices configured to:
control the movement of the tool by the one or more linear drives; and
determine if tool damage will occur based on the movement of the tool from the first position to the one or more test position.

8. The apparatus of claim 7, wherein the one or more computing devices are configured to monitor the sensed load by the one or more load sensors, compare the sensed load to a threshold value, and determine if the tool contacted the workpiece when the tool is moved from the first position to the one or more test positions.

9. The apparatus of claim 8, wherein the sensed load is one of an absolute load, a relative load, and rate of change of the load.

10. A computer controlled apparatus for resurfacing at least one surface of a workpiece, the apparatus comprising:
a workpiece support configured to support a workpiece having the at least one surface;
a tool carried by a tool carriage;
one or more linear drives configured and arranged to move the tool, with respect to the workpiece, to a first position and from the first position to one or more test positions, the one or more linear drives including one or more electric motors; and
one or more computing devices that include
a machining module configured to control the movement of the tool for resurfacing the at least one surface of the workpiece; and
a tool damage prevention module configured to determine whether the tool contacts a surface of a workpiece in a potentially damaging manner prior to resurfacing.
